(19) United States
(12) Patent Application Publication
(10) Pub. No.: US 2018/0262588 A1
(43) Pub. Date: Sep. 13, 2018

(54) SYSTEM, SERVER AND METHOD FOR TRANSMITTING MULTIMEDIA DATA

(71) Applicant: Delta Networks, Inc., Taoyuan City (TW)

(72) Inventors: Ying-Ku LIN, Taoyuan City (TW); Chieh-Lun CHIA, Taoyuan City (TW); Jyh-Ming KUO, Taoyuan City (TW); Chi-Wa TONG, Taoyuan City (TW); Yong-Sin LUO, Taoyuan City (TW)

(21) Appl. No.: 15/724,539

(22) Filed: Oct. 4, 2017

(30) Foreign Application Priority Data
Mar. 10, 2017 (CN) 201710144215.4

(51) Int. Cl. H04L 29/08

(52) U.S. Cl. CPC H04L 67/26; H04L 67/34; H04L 67/18; H04L 67/10

(57) ABSTRACT

A system for transmitting multimedia data is provided. The system includes a server and a plurality of terminal stations. The terminal stations are coupled to the server. The server receives at least one multimedia data transmitted from a content provider, generates a plurality of packages according to a packaging signal, wherein each package includes a description file, and respectively transmits the packages to the corresponding terminal stations according to the description files.

### CROSS REFERENCE TO RELATED APPLICATIONS

This Application claims priority of China Patent Application No. 201710144215.4, filed on Mar. 10, 2017, the entirety of which is incorporated by reference herein.

### BACKGROUND OF THE INVENTION

### Field of the Invention

Aspects of the present disclosure relate generally to a method, a server and a system for transmitting multimedia data, and more particularly, to a method, a server and a system for transmitting multimedia data in a cloud environment.

### Description of the Related Art

Vehicles, such as automobiles and aircraft, often include multimedia systems for satisfying passenger demands for access to viewing content, such as entertainment, information content, or other viewing content, while traveling.

Conventional passenger information (or entertainment) systems typically include video systems with individual controls or seat-based video systems such that multimedia content is selectable by the passengers. The multimedia content can include audio and video content that is derived from a variety of content sources. Prerecorded multimedia content, such as movies and music, can be provided by internal content sources, such as audio and video players, that are installed aboard the vehicle.

Furthermore, passenger demand for multimedia content is continually evolving. Not only do passengers want to access the most current multimedia content, such as live television programming and the latest games, but they also require a more extensive selection of information products and services, such as Internet access and in-transit shopping, to be available. Conventional passenger multimedia systems, however, are limited by their fixed hardware technology and cannot easily be adapted to accommodate changing passenger multimedia content and other information preferences.

In view of the foregoing, the need exists for a method and system for transmitting multimedia data to overcome the aforementioned obstacles and deficiencies of conventional passenger multimedia systems.

### BRIEF SUMMARY OF THE INVENTION

The following summary is illustrative only and is not intended to be limiting in any way. That is, the following summary is provided to introduce concepts, highlights, benefits, and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

A method, a server and a system for transmitting multimedia data are provided in the disclosure.

In a preferred embodiment, the disclosure is directed to a system for transmitting multimedia data. The system comprises a server and a plurality of terminal stations coupled to the server. The server further executes: receives at least one multimedia data transmitted from a content provider, generates a plurality of packages according to a packaging signal, wherein each package includes a description file, and respectively transmits the packages to the corresponding terminal stations according to the description files.

In some embodiments, before the server receives the multimedia data transmitted from the content provider, the server parses the multimedia data, checks whether the multimedia data contains errors, and receives the multimedia data when the multimedia data does not contain errors. In some embodiments, the system further comprises a content management device and a simulation station. After the server generates the packages, the server transmits the packages to the simulation station, receives a preview signal transmitted from the content management device, and transmits configuration information to the simulation station according to the preview signal so that the simulation station changes the configuration of the simulation station to a simulation preview configuration according to the configuration information. In some embodiments, the system further comprises a content management device coupled to the server. After the server generates the packages, the server receives a deployment signal transmitted from the content management device, reads the description file according to the deployment signal, creates a catalog of files according to an attribute in the description file, and transmits the packages to the terminal stations that correspond to the attribute according to the catalog of files. In some embodiments, the server receives a station-added signal, wherein the station-added signal includes attribute configuration information, generates installation software according to the attribute configuration information, and transmits the installation software to a new terminal station. In some embodiments, the description file at least includes an identifier of the terminal station and geographic information of the terminal station. In some embodiments, the system further comprises a smart device server (SDS) coupled to the simulation station and directly accessing the packages of the simulated station and an electronic device. The electronic device is connected to the SDS in a wired or wireless manner and then previews and actually operates the packages.

In a preferred embodiment, the disclosure is directed to a server for transmitting multimedia data. The server comprises a control circuit, a processor and a memory. The processor is installed in the control circuit. The memory is installed in the control circuit and is operatively coupled to the processor. The processor is configured to execute program code stored in the memory to perform operations comprising: receiving at least one multimedia data transmitted from a content provider; generating a plurality of packages according to a packaging signal, wherein each package includes a description file; and respectively transmitting the packages to the corresponding terminal stations according to the description files.

In some embodiments, before the server receives the multimedia data transmitted from the content provider, the server further executes the program code to perform operations comprising: parsing the multimedia data; checking whether the multimedia data contains errors; and receiving the multimedia data when the multimedia data does not contain errors. In some embodiments, after the server generates the packages, the server further executes the program code to perform operations comprising: transmitting the packages to a simulation station; receiving a preview signal transmitted from a content management device; and transmitting configuration information to the simulation station according to the preview signal so that the simulation station changes the configuration of the simulation station to a simulation preview configuration according to the configuration information. In some embodiments, after the server generates the packages, the server further executes the program code to perform operations comprising: receiving a deployment signal transmitted from a content management device; reading the description file according to the deployment signal; creating a catalog of files according to an attribute in the description file; and transmitting the packages to the terminal stations that correspond to the attribute according to the catalog of files. In some embodiments, the server further executes the program code to perform operations comprising: receiving a station-added signal, wherein the station-added signal includes attribute configuration information; generating installation software according to the attribute configuration information; and transmitting the installation software to a new terminal station. In some embodiments, the description file at least includes identifiers of the terminal stations and geographic information of the terminal stations.

In a preferred embodiment, the disclosure is directed to a method for transmitting multimedia data, used in a system, comprising: receiving, by a server, at least one multimedia data transmitted from a content provider; generating, by the server, a plurality of packages according to a packaging signal, wherein each package includes a description file; and respectively transmitting, by the server, the packages to a plurality of corresponding terminal stations according to the description files.

In a preferred embodiment, the disclosure is directed to a method for transmitting multimedia data, used in a server, comprising: receiving at least one multimedia data transmitted from a content provider; generating a plurality of packages according to a packaging signal, wherein each package includes a description file; and respectively transmitting the packages to a plurality of corresponding terminal stations according to the description files.

In a preferred embodiment, the disclosure is directed to a system for transmitting multimedia data. The system comprises a master server, a plurality of slave servers and a plurality of terminal stations. The terminal stations are coupled to the master server and the slave servers. The master server further executes: receiving at least one multimedia data transmitted from a content provider; generating a plurality of packages according to a packaging signal, wherein each package includes a description file; and respectively transmitting the packages to the corresponding terminal stations according to the description files.

A detailed description is given in the following embodiments with reference to the accompanying drawings.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to the size in actual implementation in order to clearly illustrate the concept of the present disclosure.

FIG. 1A illustrates an example of a system for transmitting multimedia data according to embodiments of the present disclosure.

FIGS. 1B-1D are exemplary schematic diagrams showing architecture of the system according to another embodiment of the present disclosure.

FIG. 2 shows an alternative simplified functional block diagram of a device according to one embodiment of the present disclosure.

FIG. 3 is a flow diagram of a process illustrating a method for transmitting multimedia data in the system according to an embodiment of the disclosure with reference to the system in FIGS. 1A and 1B.

FIG. 4 is a schematic diagram of package architecture in accordance with an embodiment of the present disclosure.

FIG. 5 is a schematic diagram of adding a new terminal station to the system in accordance with an embodiment of the present disclosure.

FIG. 6 is a schematic diagram of adding a new slave server to the system in accordance with an embodiment of the present disclosure.

FIG. 7 is a schematic diagram of adding a standby server to the system in accordance with an embodiment of the present disclosure.

FIG. 8 is a flow diagram illustrating a method for transmitting multimedia data in accordance with an embodiment of the present disclosure.

### DETAILED DESCRIPTION OF THE INVENTION

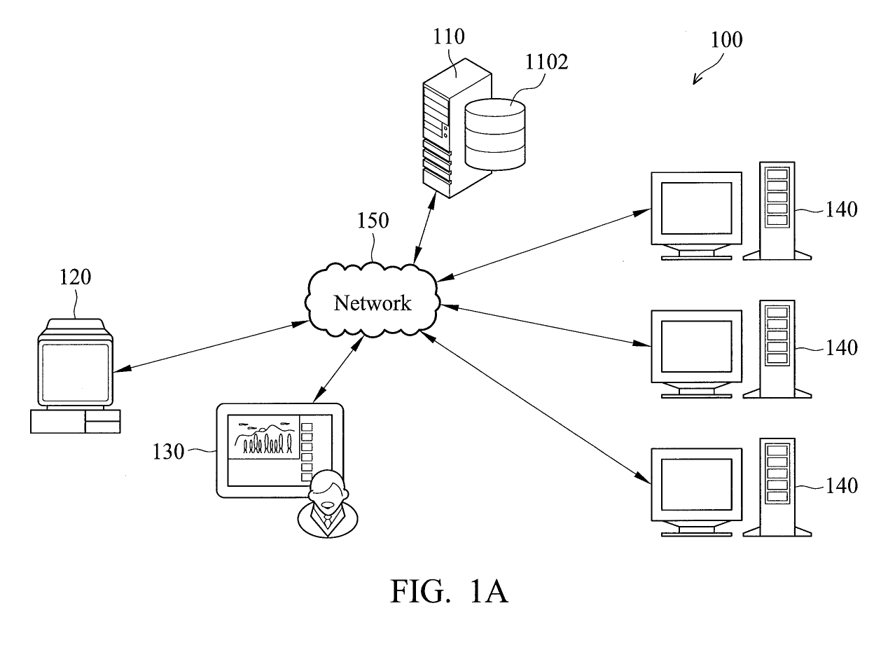

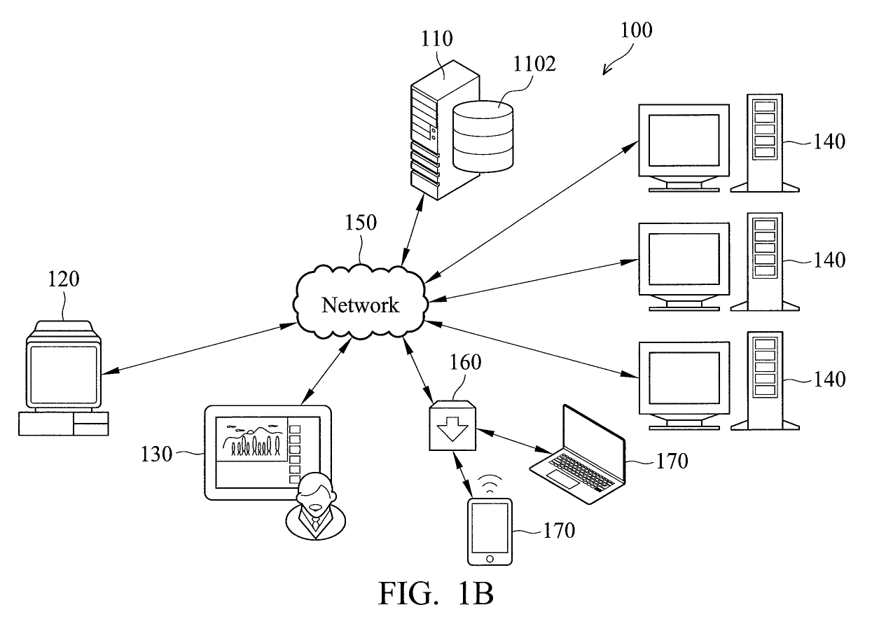

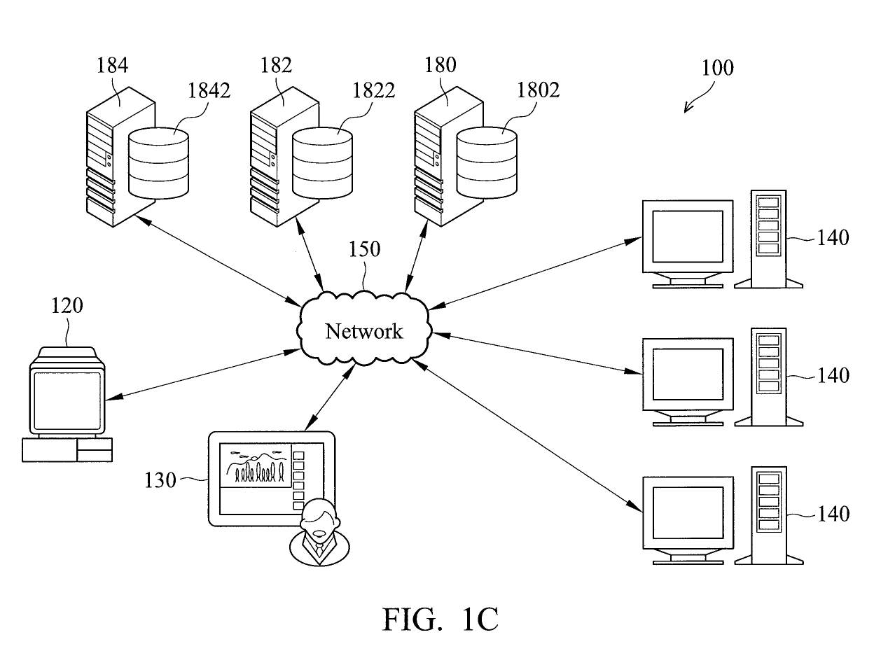

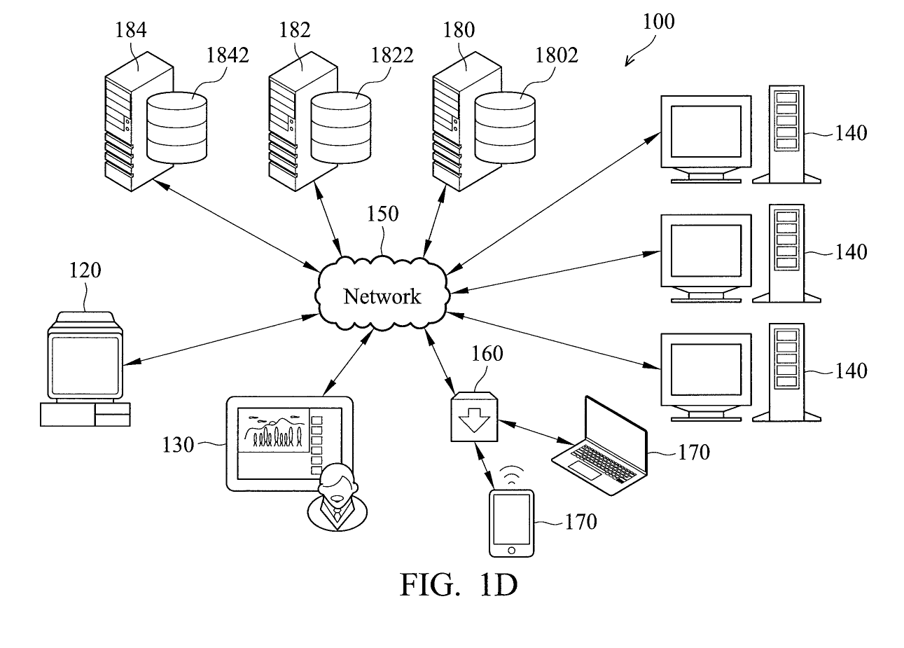

Several exemplary embodiments of the present disclosure are described with reference to FIGS. 1A through 8, which generally relate to a method, a server and a system for transmitting multimedia data. It should be understood that the following disclosure provides various embodiments as examples for implementing different features of the present disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The term “exemplary” means that the disclosed element or embodiment is only an example, and does not indicate any preference of user. Further, like numerals refer to like elements throughout the several views, and the articles “a” and “the” includes plural references, unless otherwise specified in the description.

FIG. 1A illustrates an example of a system 100 for transmitting multimedia data according to embodiments of the present disclosure. As shown in FIG. 1A, the system 100 comprises a server 100, a content provider 120, a content management device 130 and a plurality of terminal stations 140.

The content provider 120, the content management device 130 and the terminal stations 140 may be any other electronic device, such as a computer, Internet-enabled mobile telephone, and/or personal digital assistant (PDA), capable of communicating via a network (e.g., the network 150 described in FIG. 1A) and/or displaying and navigating web pages or other types of electronic documents. It should be noted that although the number of terminal stations 140 in FIG. 1A used in this example is three, it should not be limited in the disclosure.

In the embodiment, the system 100 may also include a network 150. The network 150 may can be any type of network familiar to those skilled in the art that can support data communications using any of a variety of commercially-available protocols, including without limitation TCP/IP and so on. Merely by way of example, the network 150 maybe a local area network (LAN), such as an Ethernet network and/or the like; a virtual network, including without limitation a virtual private network (VPN); the Internet; a wireless network (e.g., a network operating under any of the IEEE 802.11 suite of protocols; and/or any combination of these and/or other networks.

The server 110 may communicate with the content provider 120, the content management device 130 and the terminal stations 140 through the network 150. The server 110 may check the multimedia data and may provide intelligent auxiliary information to correct the multimedia data for reducing mistakes caused by human operation and improving a correct rate before the content provider 120 uploads the multimedia data to the server 110. The server 110 may also provide a service for the content provider 120 to upload the multimedia data, wherein the server 110 may use the highest specification security standard “Hollywood Content” to protect the multimedia data uploaded by the content provider 120 during the upload of the multimedia data by the content provider 120, and may analyze an attribute of the content provider 120 to adjust the transmission mode between the server 110 and the content provider 120. In addition, the server 110 may maintain a database 1102 which can record the multimedia data stored on the server 110.

After the content provider 120 uploads the multimedia data, the server 110 can continuously track and analyze the relevant information of the multimedia data, such as the number of times that the multimedia data is packed and referenced, the number of times that the multimedia data is accessed on the electronic device, and a modification and maintenance record related to the multimedia data, etc., to allow the content provider 120 to adjust the information of the multimedia data. The server 110 can parse the multimedia data and optimize the multimedia data for enabling the multimedia data to support a plurality of types of multimedia systems after uploading the multimedia data. An operator may transmit a packaging signal to the server 110 via the content management device 130, so that the server 110 can pack the optimized multimedia data individually according to different transportation areas or the type of passenger and can produce a plurality of packages with different attributes, wherein one package may be applied to one or more transportation vehicles, and each package includes a description file. The description file at least includes the attribute of the package (for example, an expiration date, a type of transportation vehicle, a version of multimedia system, etc.), an identifier of the terminal station and geographic information of the terminal station, and so on. The server 110 may transmit the packages to the terminal stations 140 that correspond to an attribute according to the attribute included in the description file after generating the packages.

FIG. 1B is an exemplary schematic diagram showing an architecture of the system 100 according to another embodiment of the present disclosure. In FIG. 1B, components having the same name as those described in FIG. 1A have the same function, so the details related to these components of the system will be omitted. The main difference between FIG. 1B and FIG. 1A is that a simulation station 160 and a plurality of electronic devices 170 are further included in FIG. 1B, wherein the simulation station 160 can be connected to the electronic device 170 in a wired or wireless manner. It should be noted that although the number of electronic devices 170 in FIG. 1B used in this example is two, it should not be limited in the disclosure. The application of the simulation station 160 will be described below.

FIG. 1C is an exemplary schematic diagram showing an architecture of a system 100 according to another embodiment of the present disclosure. As shown in FIG. 1C, the system 100 includes a master server 180, a plurality of slave servers 182 and 184, a content provider 120, a content management device 130, and a plurality of terminal stations 140. The master server 180 in FIG. 1C is the same as the server 110 in FIG. 1A. For convenience of explanation, the server 180 is referred to a “master server” in FIG. 1C. Components having the same name as those described in FIG. 1A have the same function, so the details related to these components of the system will be omitted.

The main difference between FIG. 1C and FIG. 1A is that the system 100 further comprises a plurality of slave servers 182 and 184. The master server 180 and the slave servers 182 and 184 may communicate with the content provider 120, the content management device 130 and the terminal stations 140 via the network 150. The master server 180 may check the multimedia data and may provide intelligent auxiliary information to correct the multimedia data for reducing mistakes caused by human operation and improving a correctness rate before the content provider 120 uploads the multimedia data to the master server 180. The master server 180 may also provide a service for the content provider 120 to upload the multimedia data, wherein the master server 180 may use the highest specification security standard “Hollywood Content” to protect the multimedia data uploaded by the content provider 120 during the upload of the multimedia data by the content provider 120, and may analyze the attribute of the content provider 120 to adjust a transmission mode between the master server 180 and the content provider 120. In addition, the master server 180 may maintain a database 1802 which can record the multimedia data stored on the master server 180. Similarly, the slave servers 182 and 184 may maintain their respective databases 1822 and 1842.

After the content provider 120 uploads the multimedia data, the master server 180 can continuously track and analyze the relevant information of the multimedia data, such as the number of times that the multimedia data is packed and referenced, the number of times that the multimedia data is accessed on the electronic device, and a modification and maintenance record related to the multimedia data, etc., to allow the content provider 120 to adjust the information of the multimedia data. The master server 180 can parse the multimedia data and optimize the multimedia data for enabling the multimedia data to support a plurality of types of multimedia systems after uploading the multimedia data. The operator may transmit a packaging signal to the master server 180 via the content management device 130, so that the master server 180 can pack the optimized multimedia data individually according to different transportation areas or the type of passenger and can produce a plurality of packages with different attributes, wherein one package may be applied to one or more transportation vehicles, and each package includes a description file. The description file at least includes the attribute of the package (for example, an expiration date, a type of transportation vehicle, a version of multimedia system, etc.), an identifier of the terminal station and geographic information of the terminal station, and so on. The master server 180 may separately transmit the packages to the terminal stations 140 that correspond to an attribute with the slave servers 182 and 184 according to the attribute included in the description file after generating the packages.

FIG. 1D is an exemplary schematic diagram showing an architecture of a system 100 according to another embodiment of the present disclosure. In FIG. 1D, components having the same name as those described in FIG. 1C have the same function, so the details related to these components of the system will be omitted. The main difference between FIG. 1D and FIG. 1C is that a simulation station 160 and a plurality of electronic devices 170 are further included in FIG. 1D, wherein the simulation station 160 can be connected to the electronic device 170 in a wired or wireless manner. It should be noted that although the number of electronic devices 170 in FIG. 1D used in this example is two, it should not be limited in the disclosure. The application of the simulation station 160 will be described below.

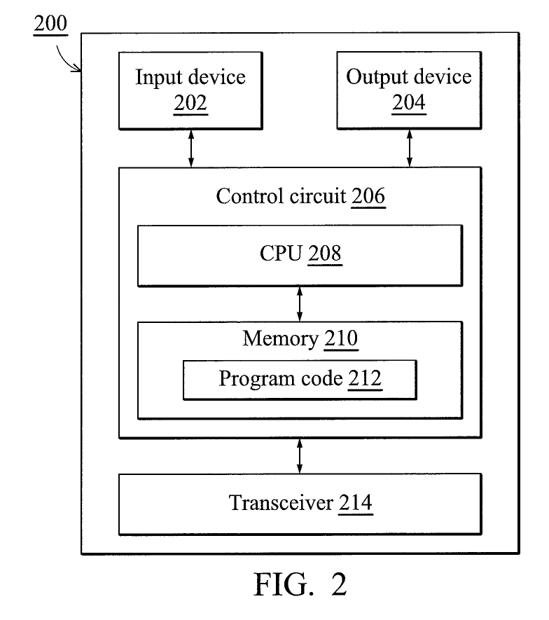

FIG. 2 shows an alternative simplified functional block diagram of a device 200 according to one embodiment of the present disclosure. As shown in FIG. 2, the device 200 can be the server 110, the master server 180, the slave servers 182 and 184, the content provider 120, the content management device 130, the terminal stations 140, the simulation station 160 and the electronic devices 170 in the system 100 of FIGS. 1A-4D. The device 200 may include an input device 202, an output device 204, a control circuit 206, a central processing unit (CPU) 208, a memory 210, program code 212, and a transceiver 214. The control circuit 206 executes the program code 212 in the memory 210 through the CPU 208, thereby controlling the operation of the device 200. The device 200 can receive signals input by a user through the input device 202, such as a keyboard keypad, touch screen, or microphone (for voice input), and can output images and sounds through the output device 204, such as a screen or speakers. The transceiver 214 is used to receive and transmit wireless signals, deliver received signals to the control circuit 206, and output signals generated by the control circuit 206 wirelessly.

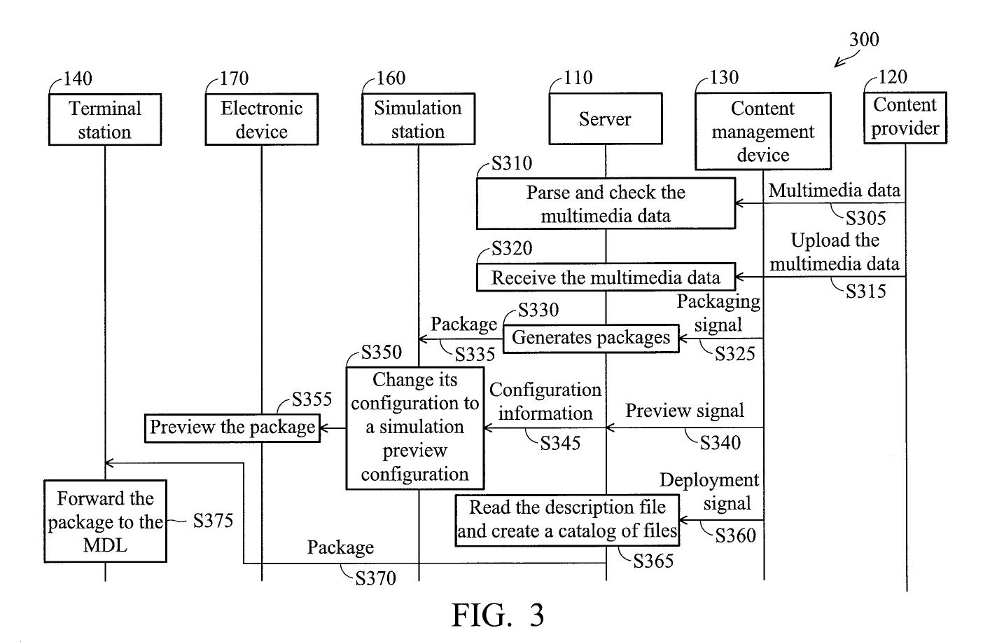

FIG. 3 is a flow diagram 300 of a process illustrating a method for transmitting multimedia data in the system according to an embodiment of the disclosure with reference to the system in FIGS. 1A and 1B. In step S305, the content provider 120 inputs a multimedia data to the server 110. In step S310, the server 110 parses the multimedia data and checks whether the multimedia data contains errors. For example, the integrity of multimedia data, the correctness of each data format in the multimedia data, the DRM protection for the multimedia data, and so on. When an error is checked, the server 110 may mark the error and may report the error to the content provider 120.

When there is no error in the multimedia data, in step S315, the server 110 allows the content provider 120 to upload the multimedia data. In one embodiment, the content provider 120 may establish a secure encrypted channel (e.g., a secure VPN connection or an HTTP/HTTPS link) with the server 110 before uploading the multimedia data.

In step S320, the server 110 receives the multimedia data. In an embodiment, the server 110 may perform different processing on different types of multimedia data. For example, if the multimedia data is an image file, the server 110 may generate image files having multiple resolutions. If the multimedia data is a video file, the server 110 may check whether the format of the video file conforms to the requirements of the system. If not, the server 110 may re-encode the video file to meet the requirements of various types of multimedia systems. The server 110 may store the multimedia data in the database 112 according to a predetermined rule after processing the multimedia data.

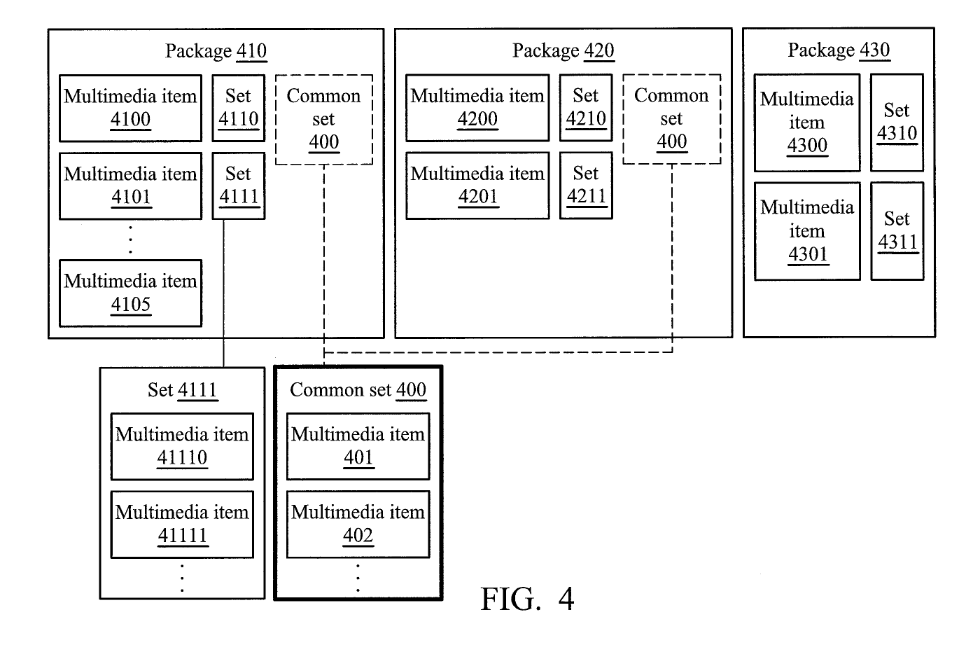

Next, in step S325, the server 110 receives a packaging signal transmitted from the content management device 130, wherein the packaging signal is used to indicate the plurality of multimedia items included in each package, the type of transportation vehicles, the expiration date and the version of the multimedia system for each package. In step S330, the server 110 generates a plurality of packages according to the packaging signal. For example, FIG. 4 is a schematic diagram of package architecture in accordance with an embodiment of the present disclosure. It is assumed that the server 110 generates a package 410, a package 420 and a package 430 according to the packaging signal. The package 410 includes multimedia items 4100 to 4105, a set 4110, a set 4111 and a common set 400, wherein each set may contain a multimedia item selected by a user through the packaging signal. The common set 400 is respectively included in the package 410 and the package 420. When a new multimedia item is added to the common set 400, the new multimedia item will also be added to the package 410 and the package 420, but not added to the package 430. When the multimedia item is removed from the common set 400, the multimedia item will also be removed from the package 410 and the package 420. When a multimedia item, which is also included in the common set 400, is removed from the package 410, the multimedia item is not removed from the common set 400.

In step S335, the server 110 transmits the package(s) to the simulation station 160. In step S340, the server 110 receives a preview signal transmitted from the content management device 130. In step S345, the server 110 transmits configuration information to the simulation station 160. In step S350, the simulation station 160 changes its configuration to a simulation preview configuration according to the configuration information. In step S355, the electronic device 170 may preview the package(s) through a smart device server (SDS). Specifically, the SDS may be coupled to the simulation station 160 and directly access the packages of the simulated station 160. The electronic device 170 may be connected to the SDS in a wired or wireless manner, and then may preview and actually operate dynamic content in the package.

In step S360, the server 110 may also receive a deployment signal transmitted from the content management device 130. In step S365, the server 110 reads the description file in the package according to the deployment signal and creates a catalog of files according to an attribute in the description file. In step S370, the server 110 transmits the package(s) to the terminal station 140 that correspond to the attribute according to the catalog of files.

It should be noted that the server 110 may transmit a deployment notification and a transmission specification file to the terminal station 140 before transmitting the package(s) to the terminal station 140. The terminal station 140 compares the multimedia data on the terminal station 140 with the multimedia data on the server 110 and establishes a list of differences. Then, the terminal station 140 may establish a secure encryption protocol channel with the server 110 according to the transmission specification file and receive the files in the package according to the list of differences.

After the terminal station 140 receives the package(s), in step S375, the terminal station 140 may establish a secure encrypted channel (for example, a secure VPN connection, or an HTTP/HTTPS link) with a plurality of media loaders (MDLs) and forward the package to the MDL. After the terminal station 140 forwards the package(s), the operator may carry the MDL to the target transportation vehicle, or wirelessly transmit the package included in the MDL to the multimedia system on the transportation vehicle. In one embodiment, the MDL may be connected to a local area network to report an update record and the multimedia data usage record to the terminal station 140 after transmitting the package(s). The terminal station 140 may report the update record to the server 110 after receiving the update record reported by the MDL.

In another embodiment, the system of FIGS. 1C and 1D may also be applied to FIG. 3. The master server 180 of FIGS. 1C and 1D may perform the operations of the server 110 in FIG. 3. In step S335, the master server 180 may separately transmit the packages to the simulation station 160 with the slave servers. In addition, in step S370, the master server 180 may also separately transmit the package(s) to the terminal station(s) 140 that correspond to the attribute with the slave servers.

It should be noted that the master server 180 may transmit an deployment notification and a transmission specification file to the terminal station 140 before transmitting the package(s) to the terminal station 140. The terminal station 140 compares the multimedia data on the terminal station 140 with the multimedia data on the master server 180 and establishes a list of differences. Then, the terminal station 140 may establish a secure encryption protocol channel with the master server 180 according to the transmission specification file and transmit a connection request to the master server 180 according to the list of differences. The master server 180 finds a connection which is the most suitable for transmission between the terminal station 140 and the master server 180 or the slave servers. The terminal station 140 respectively receives the files in the package(s) from the master server 180 or the slave servers according to the connection.

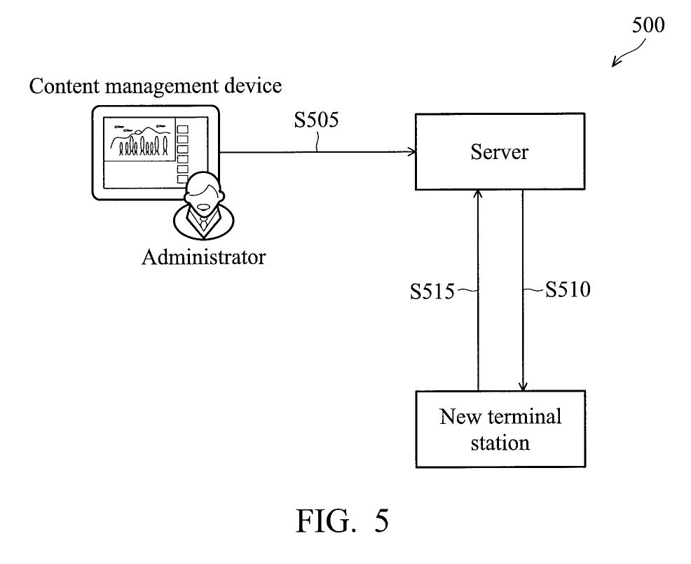

FIG. 5 is a schematic diagram 500 of adding a new terminal station to the system in accordance with an embodiment of the present disclosure. In step S505, an administrator may transmit a station-added signal to the server via the content management device, wherein the station-added signal includes attribute configuration information. The server generates installation software according to the attribute configuration information after receiving the station-added signal, wherein the installation software is single-use software. Next, in step S510, the server transmits the installation software to the new terminal station. In step S515, after the installation software is installed on the new terminal station, the new terminal station can transmit an installation completion message to the server to inform the server that the new terminal station has been added and has the ability to deploy the multimedia data.

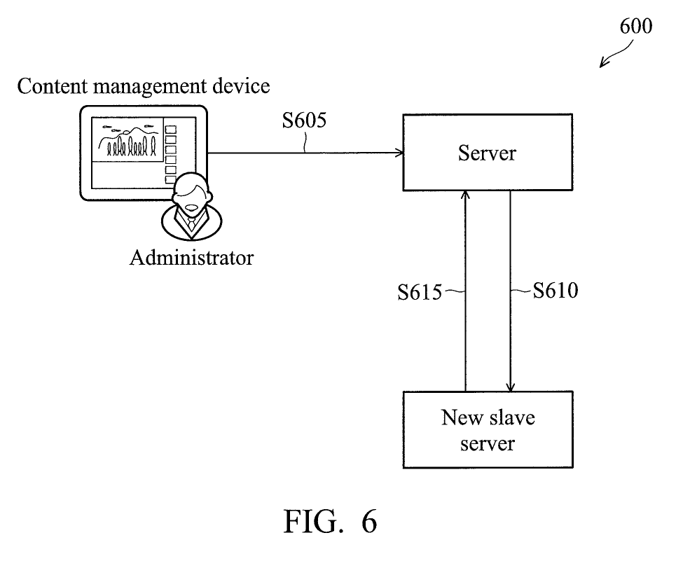

FIG. 6 is a schematic diagram 600 of adding a new slave server to the system in accordance with an embodiment of the present disclosure. In step S605, the administrator may transmit a slave-server-added signal to the server via the content management device, wherein the slave-server-added signal includes attribute configuration information. The server generates installation software according to the attribute configuration information after receiving the slave-server-added signal, wherein the installation software is single-use software. Next, in step S610, the server transmits the installation software to the new terminal station. In step S615, after the installation software is installed on the new slave server, the new slave server can transmit an installation completion message to the server to inform the server that the new slave server has been added and has the ability to separately transmit, upload, and download the multimedia data.

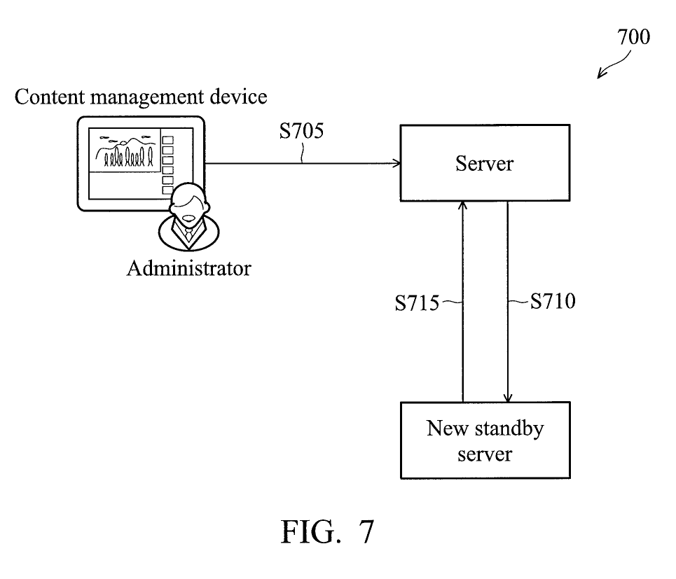

FIG. 7 is a schematic diagram 700 of adding a standby server to the system in accordance with an embodiment of the present disclosure. In step S705, the administrator may transmit a standby-server-added signal to the server via the content management device, wherein the standby-server-added signal includes attribute configuration information. The server generates installation software according to the attribute configuration information after receiving the standby-server-added signal, wherein the installation software is single-use software. Next, in step S710, the server transmits the installation software to a new standby server. In step S715, after the installation software is installed on the new standby server, the new standby server can transmit an installation completion message to the server to inform the server that the new standby server has been added and has the ability to provide immediate support.

It should be noted that the steps of FIGS. 5-7 are performed by the server, but the steps may also be performed by the master server connected to the slave servers.

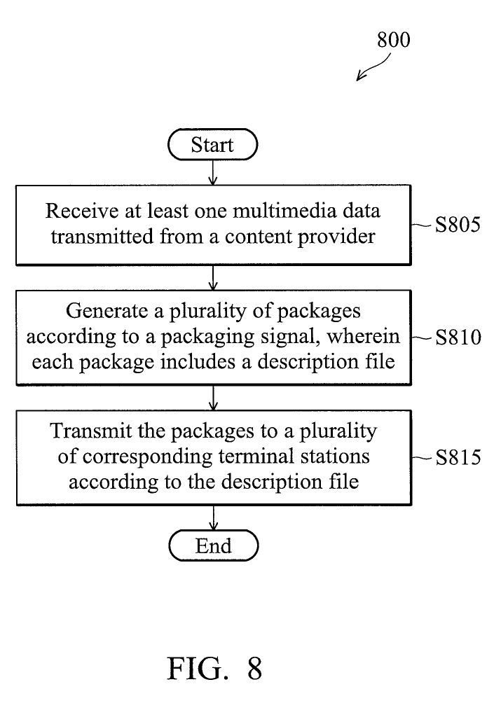

FIG. 8 is a flow diagram 800 illustrating a method for transmitting multimedia data in accordance with an embodiment of the present disclosure. The method is used in a server, such as the server 110 of FIGS. 1A and 1B or the master server 180 of FIGS. 1C and 1D. In step S805, the server receives at least one multimedia data transmitted from a content provider. Next, in step S810, the server generates a plurality of packages according to a packaging signal, wherein each package includes a description file. In step S815, the server transmits the packages to a plurality of corresponding terminal stations according to the description file.

In addition, in the above exemplary system, although the method has been described on the basis of the flow diagram using a series of the steps or blocks, the present disclosure is not limited to the sequence of the steps, and some of the steps may be performed in order different from that of the remaining steps or may be performed simultaneously with the remaining steps. For example, the server may first receive the preview signal transmitted from the content management device, and then may transmit the package to the simulation station. Furthermore, those skilled in the art will understand that the steps shown in the flow diagram are not exclusive and they may include other steps or one or more steps of the flow diagram may be deleted without affecting the scope of the present disclosure. For example, steps S340, S345, S350 and S355 of FIG. 3 can be omitted.

In addition, the central processing unit 208 can execute the program code 212 to perform all of the actions and steps described above or others described herein.

Therefore, the multimedia data can be updated without being restricted by a specific time and a geographic location through the method, the server and the system for transmitting multimedia data provided in the present disclosure, so that the passenger can obtain the best experience on the transportation vehicles.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using another structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those with skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those with skill in the art will further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in various ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application-specific integrated circuit (ASIC), a field programmable gate array (FPGA) or another programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It should be understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it is to be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for transmitting multimedia data, comprising:
a server; and
a plurality of terminal stations, coupled to the server;
wherein the server receives at least one multimedia data transmitted from a content provider, generates a plurality of packages according to a packaging signal, wherein each package includes a description file, and respectively transmits the packages to the corresponding terminal stations according to the description files.

2. The system for transmitting multimedia data as claimed in claim 1, wherein before the server receives the multimedia data transmitted from the content provider, the server parses the multimedia data, checks whether the multimedia data contains errors, and receives the multimedia data when the multimedia data does not contain errors.

3. The system for transmitting multimedia data as claimed in claim 1, further comprising:
a content management device; and
a simulation station;
wherein after the server generates the packages, the server transmits the packages to the simulation station, receives a preview signal transmitted from the content management device, and transmits configuration information to the simulation station according to the preview signal so that the simulation station changes the configuration of the simulation station to a simulation preview configuration according to the configuration information.

4. The system for transmitting multimedia data as claimed in claim 1, further comprising:
a content management device, coupled to the server;
wherein after the server generates the packages, the server receives a deployment signal transmitted from the content management device, reads the description file according to the deployment signal, creates a catalog of files according to an attribute in the description file, and transmits the packages to the terminal stations that correspond to the attribute according to the catalog of files.

5. The system for transmitting multimedia data as claimed in claim 1, wherein the server receives a station-added signal, wherein the station-added signal includes attribute configuration information, generates installation software according to the attribute configuration information, and transmits the installation software to a new terminal station.

6. The system for transmitting multimedia data as claimed in claim 1, wherein the description file at least includes an identifier of the terminal station and geographic information of the terminal station.

7. The system for transmitting multimedia data as claimed in claim 3, further comprising:
a smart device server (SDS), coupled to the simulation station and directly accessing the packages of the simulated station; and
an electronic device;
wherein the electronic device is connected to the SDS in a wired or wireless manner and then previews and actually operates the packages.

8. A server for transmitting multimedia data, comprising:
a control circuit;
a processor installed in the control circuit;
a memory installed in the control circuit and operatively coupled to the processor;
wherein the processor is configured to execute program code stored in the memory to perform operations comprising:
receiving at least one multimedia data transmitted from a content provider;
generating a plurality of packages according to a packaging signal, wherein each package includes a description file; and
respectively transmitting the packages to the corresponding terminal stations according to the description files.

9. The server for transmitting multimedia data as claimed in claim 8, wherein before the server receives the multimedia data transmitted from the content provider, the server further executes the program code to perform operations comprising:
parsing the multimedia data;
checking whether the multimedia data contains errors; and
receiving the multimedia data when the multimedia data does not contain errors.

10. The server for transmitting multimedia data as claimed in claim 8, wherein after the server generates the packages, the server further executes the program code to perform operations comprising:
transmitting the packages to a simulation station;
receiving a preview signal transmitted from a content management device; and
transmitting configuration information to the simulation station according to the preview signal so that the simulation station changes the configuration of the simulation station to a simulation preview configuration according to the configuration information.

11. The server for transmitting multimedia data as claimed in claim 8, wherein after the server generates the packages, the server further executes the program code to perform operations comprising:
receiving a deployment signal transmitted from a content management device;
reading the description file according to the deployment signal;
creating a catalog of files according to an attribute in the description file; and
transmitting the packages to the terminal stations that correspond to the attribute according to the catalog of files.

12. The server for transmitting multimedia data as claimed in claim 8, wherein the server further executes the program code to perform operations comprising:
receiving a station-added signal, wherein the station-added signal includes attribute configuration information;
generating installation software according to the attribute configuration information; and
transmitting the installation software to a new terminal station.

13. The server for transmitting multimedia data as claimed in claim 8, wherein the description file at least includes identifiers of the terminal stations and geographic information of the terminal stations.

14. A method for transmitting multimedia data, used in a system, comprising:
receiving, by a server, at least one multimedia data transmitted from a content provider;
generating, by the server, a plurality of packages according to a packaging signal, wherein each package includes a description file; and
respectively transmitting, by the server, the packages to a plurality of corresponding terminal stations according to the description files.

15. The method for transmitting multimedia data as claimed in claim 14, wherein before the server receives the multimedia data transmitted from the content provider, the method further comprises:
parsing, by the server, the multimedia data;
checking, by the server, whether the multimedia data contains errors; and
receiving, by the server, the multimedia data when the multimedia data does not contain errors.

16. The method for transmitting multimedia data as claimed in claim 14, wherein after the server generates the packages, the method further comprises:
transmitting, by the server, the packages to a simulation station;
receiving, by the server, a preview signal transmitted from a content management device; and
transmitting, by the server, configuration information to the simulation station according to the preview signal so that the simulation station changes the configuration of the simulation station to a simulation preview configuration according to the configuration information.

17. The method for transmitting multimedia data as claimed in claim 14, wherein after the server generates the packages, the method further comprises:
receiving, by the server, a deployment signal transmitted from the content management device;
reading, by the server, the description file according to the deployment signal;
creating, by the server, a catalog of files according to an attribute in the description file; and
transmitting, by the server, the packages to the terminal stations that correspond to the attribute according to the catalog of files.

18. The method for transmitting multimedia data as claimed in claim 14, wherein the method further comprises:
receiving, by the server, a station-added signal, wherein the station-added signal includes attribute configuration information;
generating, by the server, installation software according to the attribute configuration information; and
transmitting, by the server, the installation software to a new terminal station.

19. The method for transmitting multimedia data as claimed in claim 14, wherein the description file at least includes identifiers of the terminal stations and geographic information of the terminal stations.

20. The method for transmitting multimedia data as claimed in claim 16, further comprising:
directly accessing, by a smart device server (SDS), the packages of the simulated station; and
connecting, by an electronic device, to the SDS in a wired or wireless manner, and then previewing and actually operating the packages.

21. A method for transmitting multimedia data, used in a server, comprising:
receiving at least one multimedia data transmitted from a content provider;
generating a plurality of packages according to a packaging signal, wherein each package includes a description file; and
respectively transmitting the packages to a plurality of corresponding terminal stations according to the description files.

22. The method for transmitting multimedia data as claimed in claim 21, wherein before the server receives the multimedia data transmitted from the content provider, the method further comprises:
parsing the multimedia data;
checking whether the multimedia data contains errors; and
receiving the multimedia data when the multimedia data does not contain errors.

23. The method for transmitting multimedia data as claimed in claim 21, wherein after the server generates the packages, the method further comprises:
transmitting the packages to a simulation station;
receiving a preview signal transmitted from a content management device; and
transmitting configuration information to the simulation station according to the preview signal so that the simulation station changes the configuration of the simulation station to a simulation preview configuration according to the configuration information.

24. The method for transmitting multimedia data as claimed in claim 21, wherein after the server generates the packages, the method further comprises:
receiving a deployment signal transmitted from a content management device;
reading the description file according to the deployment signal;
creating a catalog of files according to an attribute in the description file; and
transmitting the packages to the terminal stations that correspond to the attribute according to the catalog of files.

25. The method for transmitting multimedia data as claimed in claim 21, comprising:
receiving a station-added signal, wherein the station-added signal includes attribute configuration information;
generating installation software according to the attribute configuration information; and
transmitting the installation software to a new terminal station.

26. The method for transmitting multimedia data as claimed in claim 21, wherein the description file at least includes identifiers of the terminal stations and geographic information of the terminal stations.

27. A system for transmitting multimedia data, comprising:
a master server and a plurality of slave servers; and
a plurality of terminal stations, coupled to the master server and the slave servers;
wherein the master server further
receiving at least one multimedia data transmitted from a content provider;
generating a plurality of packages according to a packaging signal, wherein each package includes a description file; and
respectively transmitting the packages to the corresponding terminal stations according to the description files.

28. The system for transmitting multimedia data as claimed in claim 27, wherein before the master server receives the multimedia data transmitted from the content provider, the master server further executes:
parsing the multimedia data;
checking whether the multimedia data contains errors;
receiving the multimedia data when the multimedia data does not contain errors; and
transmitting the multimedia data to the slave servers to maintain coherence between the master server and the slave servers.

29. The system for transmitting multimedia data as claimed in claim 27, further comprising:
a content management device; and
a simulation station;
wherein after the master server generates the packages, the master server further executes:
separately transmitting the packages to the simulation station with the slave servers;
receiving a preview signal transmitted from the content management device; and
transmitting configuration information to the simulation station according to the preview signal so that the simulation station changes the configuration of the simulation station to a simulation preview configuration according to the configuration information.

30. The system for transmitting multimedia data as claimed in claim 27, further comprising:
a content management device, coupled to the master server;
wherein after the master server generates the packages, the master server further executes:
receiving a deployment signal transmitted from the content management device;
reading the description file according to the deployment signal;
creating a catalog of files according to an attribute in the description file; and
separately transmitting the packages to the terminal stations that correspond to the attribute with the slave servers according to the catalog of files.

31. A method for transmitting multimedia data, used in a system, wherein the system comprises a master server and a plurality of slave servers, the method comprising:
receiving, by the master server, at least one multimedia data transmitted from a content provider;
generating, by the master server, a plurality of packages according to a packaging signal, wherein each package includes a description file; and
respectively transmitting, by the master server, the packages to a plurality of corresponding terminal stations according to the description files.

32. The method for transmitting multimedia data as claimed in claim 31, before the master server receives the multimedia data transmitted from the content provider, the method further comprises:
parsing, by the master server, the multimedia data;
checking, by the master server, whether the multimedia data contains errors;
receiving, by the master server, the multimedia data when the multimedia data does not contain errors; and
transmitting, by the master server, the multimedia data to the slave servers to maintain coherence between the master server and the slave servers.

33. The method for transmitting multimedia data as claimed in claim 31, wherein after the master server generates the packages, the method further comprises:
separately transmitting, by the master server, the packages to a simulation station with the slave servers;
receiving, by the master server, a preview signal transmitted from a content management device; and
transmitting, by the master server, configuration information to the simulation station according to the preview signal so that the simulation station changes the configuration of the simulation station to a simulation preview configuration according to the configuration information.

34. The method for transmitting multimedia data as claimed in claim 31, wherein after the master server generates the packages, the method further comprises:
receiving, by the master server, a deployment signal transmitted from a content management device;
reading, by the master server, the description file according to the deployment signal;
creating, by the master server, a catalog of files according to an attribute in the description file; and
separately transmitting, by the master server, the packages to the terminal stations that correspond to the attribute with the slave servers according to the catalog of files.
